(19) United States
(12) Patent Application Publication
(10) Pub. No.: US 2005/0024653 A1
(43) Pub. Date: Feb. 3, 2005

(54) Print file editing method and apparatus and color image forming system employing the same

(76) Inventor: Je-man Seo, Suwon-si (KR)

Correspondence Address: STANZIONE & KIM, LLP, 1740 N STREET, N.W., FIRST FLOOR, WASHINGTON, DC, 20036, US

(21) Appl. No.: 10/867,815

(22) Filed: Jun. 16, 2004

(30) Foreign Application Priority Data
Jul. 30, 2003 (JP) 2003-52614

(51) Int. Cl. G06K 15/02; H04N 1/62; H04N 1/50

(52) U.S. Cl. 358/1.9; 358/1.13; 358/537; 358/531

(57) ABSTRACT

A method and apparatus used in print file editing and a color image forming system employing the same. The print file editing method includes determining whether an editing mode is set by a user; and if it is determined that the editing mode is set, a printer editing a print file requested to be printed according to an editing type input through a user interface of an image forming system, and performing printing the edited print file. According to the method and apparatus, without modifying the original image in a computer generating a print command, the print file can be directly edited in the image forming system, and the editing type can be simply and easily set such that a user-friendly editing environment can be provided.

### CROSS-REFERENCE TO RELATED APPLICATIONS

This application claims priority from Korean Patent Application No. 2003-52614, filed on Jul. 30, 2003, the contents of which are incorporated herein by reference in their entirety.

### BACKGROUND OF THE INVENTION

1. Field of the Invention

The present invention relates to a process of editing a print file, and more particularly, to a print file editing method and apparatus allowing a print file to be edited directly in a color image forming system without modifying an original image in a computer generating a print command, and a color image forming system employing the method and apparatus.

2. Description of the Related Art

Generally, when a document composed on a computer is printed by a printer, the computer needs a printer driver to drive the printer. The printer driver plays the role of converting print data, which is generated by a computer application program, into data interpretable in the printer. That is, if a print command for the print data generated in an application program of the computer is received, the printer driver divides the print data into units of pages, and appropriately processes data and control codes for each page of print data so as to be converted into data interpretable in a printer, and then transmits the converted data to the printer through a communication interface. For example, a Postscript (PS) printer driver adjusts a variety of figures, images, and letters in an application program to PS language specifications and transmits the adjusted data, and a Printer Command Language (PCL) printer driver adjusts a variety of figures, images, and letters in an application program to PCL language specifications and transmits the adjusted data to a printer.

Meanwhile, data for a printing job transmitted through a communication interface by a user is temporarily stored in a RAM in a printer. Then a predetermined interpreter stored in a ROM, for example, a PCL or PS interpreter, is accessed, and data for the printing job is converted into a printable data format, and then transferred to a printer engine. Thus, printing is performed in the printer.

However, a case where a user wishes to edit colors of the original image according to the user's desire before or after the original image is printed, through an output device such as a printer, occurs frequently. An example of an editing operation that can be performed includes removal or recombination of at least one color of colors such as cyan (C), magenta (M), yellow (Y) and black (K). Generally, a printer driver or firmware of a printer has very basic options such as setting the general sharpness of texts, graphics, and pictures. Accordingly, in order to add a change to colors of an original image to the extent that a user desires, separate graphic programs that are application programs, such as Adobe Photoshop or Corel Photo-Paint, should be used.

However, the graphic user interfaces of these programs are difficult to manipulate to even for skilled users of graphic user interfaces. In addition, there is a problem in that when a separate graphic program is used to edit the color of an original image, the file itself, which is related to the original image, is modified.

### SUMMARY OF THE INVENTION

The present invention provides a print file editing method and apparatus by which a print file can be edited in an image forming system without modifying an original image in a computer generating a print command,.

The present invention also provides a color image forming system employing the print file editing method and apparatus.

Additional aspects and advantages of the present general inventive concept will be set forth in part in the description which follows and, in part, will be obvious from the description, or may be learned by practice of the general inventive concept.

The foregoing and/or other aspect of the present general inventive concept a print file editing method that can include determining whether an editing mode is set by a user and if it is determined that the editing mode is set, editing by a printer a print file requested to be printed according to an editing type input through a user interface of an image forming system, and performing printing the edited print file.

The operation of editing a print file and performing printing of the edited print file may include, if the colors desired to be output from the image forming system are determined in accordance with the editing type, performing rendering of the determined colors, and transferring the rendered print data for each color to a print engine.

The operation of editing a print file and performing printing the edited print file may include rendering the print file for each color that is to be printed, and if the colors desired to be output from the image forming system are determined in accordance with the editing type, transferring print data of determined colors among the rendered print data for each color, to a print engine.

The operation of editing a print file and performing printing the edited print file may include rendering the print file for each color that is to be printed out, and if the printing sequence of each color to be performed in the image forming system is determined in accordance with the editing type, transferring the rendered print data for each color to a print engine according to the color printing sequence.

The operation of editing a print file and performing printing the edited print file may include, if the colors desired to be output from the image forming system are determined in accordance with the editing type, performing rendering of the determined colors, and if the print sequence for each color to be performed in the image forming system is determined in accordance with the editing type, transferring the rendered print data for each color to a print engine according to the color printing sequence.

The operation of editing a print file and performing printing the edited print file may include rendering the print file for each color that is to be printed, and if the colors desired to be output from the image forming system and the printing sequence of each color that is to be performed in the image forming system are determined in accordance with the editing type, transferring print data for each determined color among the rendered print data for each color, to a print engine according to the determined color printing sequence.

The foregoing and/or other aspect of the present general inventive concept may also be achieved by providing a print file editing apparatus in an image forming system that may include a manipulation unit through which if an editing mode is set by a user, an editing type is input by the user, and a data processing unit which if a normal mode is set, performs rendering of a print file requested to be printed according to a preset printing sequence of each color, and if the editing mode is set, processes the print file requested to be printed, according to the editing type.

The data processing unit can control rendering and/or transferring of the print file requested to be printed according to the colors desired to be output from the image forming system and/or according to a printing sequence of each color that is to be performed in the image forming system set by the editing type.

The foregoing and/or other aspect of the present general inventive concept may also be achieved by providing an image forming system that may include a manipulation unit through which if an editing mode is set by a user, an editing type is input by the user, a data processing unit which if a normal mode is set, can perform rendering of a print file requested to be printed according to a preset printing sequence of each color, and if the editing mode is set, can process the print file requested to be printed according to the editing type, and a print engine unit which by using print data processed and transferred by the data processing unit, can form a print image on a predetermined recording medium.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram showing the structure of a color image forming system to which a print file editing apparatus according to an embodiment of the present general inventive concept is applied;

FIG. 2 is a flowchart showing a method of editing a print file according to another embodiment of the present general inventive concept;

FIG. 3 is a flowchart explaining operations of a method of editing a print file according to FIG. 2;

FIG. 4 is a flowchart explaining operations of a method of editing a print file according to another embodiment of the present general inventive concept; and

FIG. 5A through 5D are examples of generating or transmitting print data for each color by using the methods of editing a print file according to the various embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, the present general inventive concept will be described in detail by explaining various embodiments thereof with reference to the attached drawings. Like reference numerals in the drawings denote like elements.

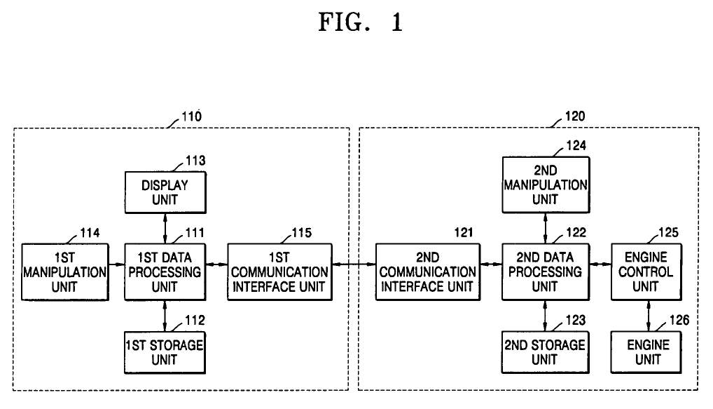

Referring to FIG. 1, a color image forming system, to which a print file editing apparatus according to an embodiment the present general inventive concept is applied, can include a computer system 110 and a printer system 120. The computer system 110 can include a first data processing unit 111, a first storage unit 112, a display unit 113, a first manipulation unit 114, and a first communication interface unit 115. The printer system 120 can include a second communication interface unit 121, a second data processing unit 122, a second storage unit 123, a second manipulation unit 124, an engine control unit 125, and an engine unit 126.

In the computer system 110, if a user inputs a print command for document data written using an application program such as a word processor, the first data processing unit 111 of the computer system 110 can convert the document data requested to be printed into print data using a printer driver. The first storage unit 112 can store a variety of control programs required to implement functions of the computer system 110, for example, the printer driver, and various data generated by executing control programs in the first data processing unit 111. The display unit 113 can be a monitor or other type of display.

The first manipulation unit 114 is formed usually with an information input device such as a keyboard, a mouse, or a touch panel, and through a user graphic interface provided by the printer driver, by which user information on whether editing will be performed in the printer system 120 is input. For this, the printer driver stored in the first storage unit 112 can be programmed so that a checkbox indicating whether editing will be performed in the printer system 120 can be provided in the user graphic interface. The first communication interface unit 115 interfaces the computer system 110 with peripheral devices such as the printer system 120. The print data generated by the first data processing unit 111 can be provided to the printer system 120 through the first communication interface unit 115.

In the printer system 120, the second communication interface unit 121 provides a communication interface with the computer system 110. The second data processing unit 122 can control the printer system 120 according to a preset program, and by using, for example, an interpreter such as PCL or PS, can convert data of a print file received through the second communication interface unit 121, into a printable data format in the engine unit 126. Also, the second data processing unit 122 can perform a different rendering procedure for the data of the print file converted by the interpreter depending on whether a normal mode or an editing mode is set by the user, and then can provide the printable data format print data for each color to the engine unit 126 through the engine control unit 125. In another embodiment, the second data processing unit 122 can provide the printable data format print data for each color generated through a rendering procedure to the engine unit 126 through the engine control unit 125 in a different printable data format print data transfer procedure depending on whether a normal mode or an editing mode is set by the user.

The second storage unit 123 can store a variety of control programs required to implement functions of the printer system 120 and can temporarily store various data being generated by performing the control programs, print data and printing information received from the computer system 110. The second manipulation unit 124 may be formed with a key matrix (not shown) and a second display unit (not shown). The key matrix can generate data according to a key pushed by the user in order to select a mode, particularly an editing mode or a normal mode, and to execute operations relevant to the selected mode, and can output the data to the second data processing unit 122. The second display unit can display the operational state of the system when each mode is performed in the second data processing unit 122. In order to perform the editing mode, editing functions may be set or a key corresponding to an editing type may be added to the key matrix in advance, or such functions may be added in the key mapping process of existing keys.

The engine control unit 125 can control the engine unit 126 so that an image corresponding to the printable data format print data for each color received from the second data processing unit 122 can be printed on the paper. For this, if a print command is received, the engine control unit 125 prepares each apparatus (not shown) forming the engine unit 126 to perform a print job. Accordingly, after the engine control unit 125 receives a print command from the second data processing unit 122, if it is determined that a print job can be performed after a print preparation period, a print start signal is applied to the second data processing unit 122. Then, the print data for each color stored in the second storage unit 123 can be to an exposure apparatus (not shown) of the engine unit 126 through the engine control unit 125.

The engine unit 126 can be formed with a variety of apparatuses required by a printing job, for example, a pickup unit, a paper feeding unit, an exposure unit, a developing unit, a transfer unit, a fusing unit, and paper exhausting units. The engine unit 126 may have any one of a variety of structures depending on a printing method.

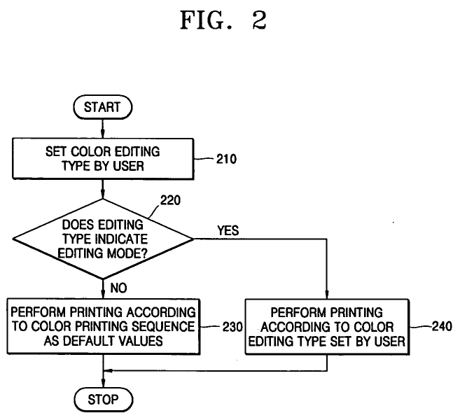

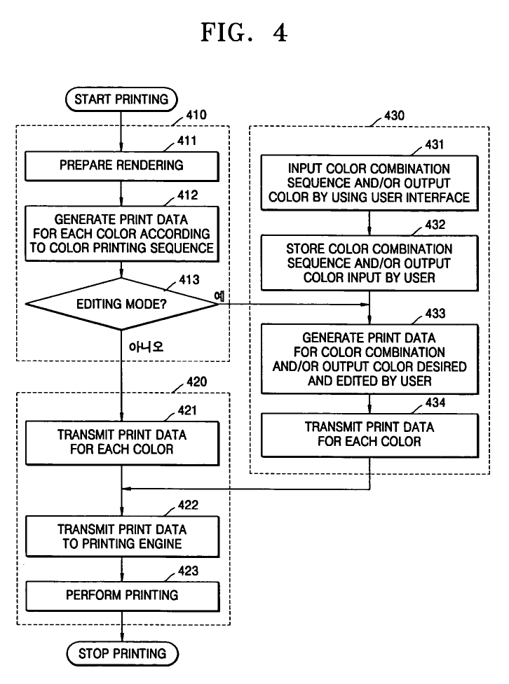

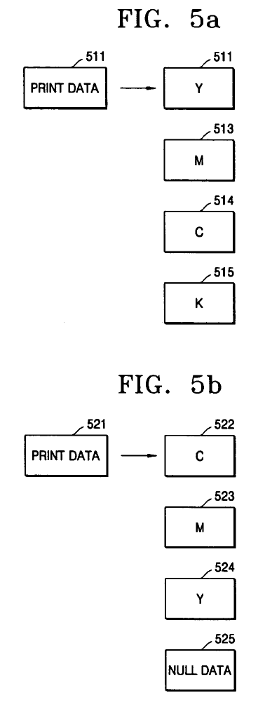

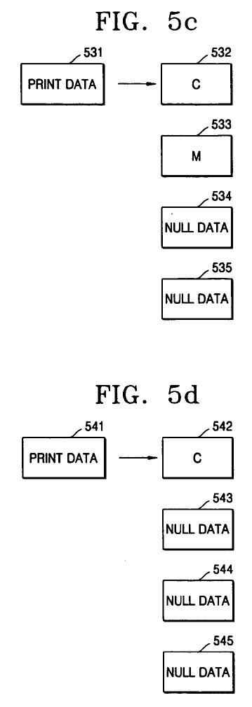

FIG. 2 is a flowchart of a method of editing a print file according to an embodiment of the present general inventive concept, and will now be explained while referring to the apparatus of FIG. 1 and FIGS. 5A through 5D.

Referring to FIG. 2, an editing type is set by the user in operation 210. Setting a color editing type includes a process of setting one between a normal mode and an editing mode using a separate key or depending on a key mapping state, and a process of selecting a color combination sequence and/or colors desired to be printed when an editing mode is selected. The normal mode or editing mode can be selected by any one of a graphic user interface provided in the printer driver and the user interface provided by the second manipulation unit 124.

Meanwhile, as an example of a color combination sequence in the editing type, that is, a color printing sequence, an order of cyan (C), magenta (M), yellow (Y), and black (K) may be set as a default, and then an order of yellow (Y), magenta (M), cyan (C), and black (K), as an example shown in FIG. 5A, may be set as the user manipulates the second manipulation unit 124. In addition to this, the sequence may be set in a variety of ways. Moreover, selecting a color desired to be printed is also possible. As shown in FIG. 5B, 3 colors, for example, cyan (C), magenta (M), and yellow (Y), are selected and one color, that is, black (K), is set to be removed, and then the color combination sequence may be changed. Also, as shown in FIG. 5C, 2 colors, for example, cyan (C) and magenta (M), are selected and 2 colors, that is, yellow (Y) and black (K), are set to be removed, and then the color combination sequence may be changed. In addition, as shown in FIG. 5D, one color, for example, cyan (C), is selected and 3 colors, that is, magenta (M), yellow (Y), and black (K), may be set to be removed. Here, for the removed colors, a data group formed by null data can be used in a rendering process and/or a transferring process.

In operation 220, it is determined whether a normal mode or an editing mode is selected by the user in operation 210. If the determination result in operation 220 indicates that the normal mode is selected, rendering is performed according to a color printing sequence set in advance as a default, and the rendered print data is provided to the engine unit 126 through the engine control unit 125.

Meanwhile, if the determination result in the operation 220 indicates that the editing mode is selected, rendering the print file that is to be printed is performed according to the editing type set by the user, and the rendered print data is provided to the engine unit 126 through the engine control unit 125.

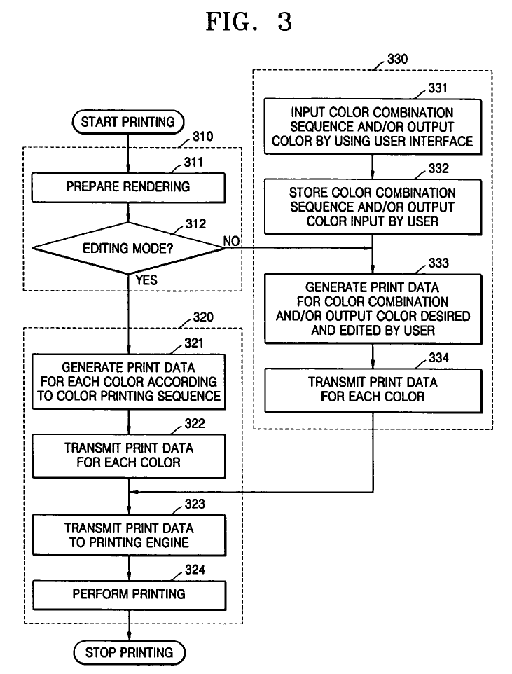

FIG. 3 is a flowchart explaining operations of a method of editing a print file according to FIG. 2.

Referring to FIG. 3, it is determined in operation 310 whether the editing mode is set by a user. For this, in operation 311, as a preparation operation of rendering, data of a print file that is to be printed by the computer system 110 is converted into a printable data format in the engine unit 126 by using an interpreter, for example, PCL or PS. In operation 312, it is determined which printing mode between a normal mode and an editing mode is set by the user. The printing mode can be set by the graphic user interface provided by the printer driver or the user interface provided by the second manipulation unit 124.

Operation 320 shows a print performing process when the normal mode is selected in operation 310. In operation 321, rendering the print file that is to be printed is performed according to a color printing sequence set in advance as a default. In operation 322, print data for each color rendered in operation 321 is provided to the engine control unit 125. In operations 323 and 324, print data for each color is transferred to the engine unit 126 and a print job is executed. Here, the rendering process entails converting colors of each pixel included in the print data converted by the interpreter into print data for each color, for example, cyan (C), magenta (M), yellow (Y), and black (K).

Operation 330 shows a print performing process when the editing mode is selected in operation 310. In operation 331, a color combination sequence and/or colors desired to be output are input by the user through the user interface of the second manipulation unit 124. Operation 331 can be performed when the user selects the editing mode, or before or after the user selects the editing mode. In operation 332, information on the color combination sequence and/or color desired to be output that is input in operation 331 is stored in the second storage unit 123. In operation 333, the second data processing unit 122 reads information on the color combination sequence and/or color desired to be output that is stored in the second storage unit 123, and performs rendering of the print file requested to be printed. In operation 334, print data for each color rendered in operation 333 is provided to the engine control unit 125.

In this embodiment, if the kind of colors desired to be printed out from the image forming system is determined in operation 331, rendering only the determined colors is performed in operation 333. Then, in operation 334, print data for each color rendered is transferred to the engine unit 126 through the engine control unit 125, and for the remaining colors, null data is generated and transferred.

Meanwhile, if the printing sequence for each color to be performed in the image forming system is determined in operation 331, rendering of the print file that is to be printed is performed in operation 333 and print data for each color, C, M, Y, and K, is generated. In operation 334, the print data is transferred to the print engine unit 126 through the engine control unit 125 according to the color printing sequence determined in operation 331.

Meanwhile, if the kind of colors desired to be printed from the image forming system and the printing sequence for each color to be performed in the image forming system are determined in operation 331, rendering of only the determined colors is performed in operation 333, and then, in operation 334, print data for each color rendered in the operation 333 is transferred to the engine unit 126 through the engine control unit 125 according to the determined color printing sequence.

FIG. 4 is a flowchart explaining the operations of a method of editing a print file according to another embodiment of the present general inventive concept. A difference of the embodiment of FIG. 4 and that of FIG. 3 is that rendering of the print file that is to be printed is first performed, and then print data is generated according to a preset color printing sequence used as a default, for example, C, M, Y, and K, and then according to whether an editing mode is set, the transfer process is controlled. Accordingly, detailed explanations of operations that are the same as those in FIG. 3 will be omitted.

Referring to FIG. 4, it is determined in operation 410 whether an editing mode is set by the user. Operation 411, which is an operation of preparing rendering, is the same as the operation 311. In operation 412, according to a preset printing sequence used as a default, rendering of the print file requested to be printed is performed in the same manner as in the operation 321. In operation 413, determining which print mode between the normal mode and the editing mode is set by the user, is done in the same manner as in the operation 312.

Operation 420 shows a print performing process when the normal mode is selected in operation 410. In the operation 421, print data for each color rendered in the operation 412 is provided to the engine control unit 125. In operations 422 and 423, print data for each color is transferred to the engine unit 126 and a print job is executed.

Operation 430 shows a print performing process when editing mode is selected in operation 410. In operations 431 and 432, a color combination sequence and/or colors desired to be output are input by the user through the second manipulation unit 124 and stored in the second storage unit 123 as in operations 331 and 332. In operation 433, the second data processing unit 122 reads information on the color combination sequence and/or colors desired to be printed that is stored in the second storage unit 123 and selects print data of colors desired to be output among the print data for each color rendered in operation 412. In operation 434, the print data for each color selected in the operation 433 is provided to the engine control unit 125.

In this embodiment, if the colors desired to be output from the image forming system are determined in operation 431, the print data for the determined colors is selected in operation 433 among the print data for each color rendered in operation 412, and transferred to the engine unit 126 through the engine control unit 125.

Meanwhile, if the printing sequence to be performed in the image forming system is determined in operation 431, all of the print data for each color rendered in operation 412 is selected in operation 433, and the print data of the selected colors are transferred to the engine unit 126 through the engine control unit 125 according to the determined color printing sequence.

Meanwhile, if the colors desired to be output from the image forming system and the printing sequence to be performed in the image forming system are determined in operation 431, the print data for the determined colors among the print data for each color rendered in operation 412 is selected in operation 433, and the print data for colors selected in operation 433 is transferred to the engine unit 126 through the engine control unit 125 according to the determined color printing sequence, in operation 434.

The present general inventive concept can also be embodied as computer readable codes on a computer readable recording medium. The computer readable recording medium is any data storage device that can store data which can be read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over networked computer systems so that the computer readable code is stored and executed so as to be distributable. Also, functional programs, codes, and code segments for accomplishing the present invention can be easily construed by programmers skilled in the art to which the present invention pertains.

According to the present general inventive concept as described above, without modifying the original image in a computer generating a print command, the print file can be edited in the image forming system itself and the editing type can be simply and easily set such that a user-friendly editing environment can be provided.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A print file editing method comprising:
determining whether an editing mode is set by a user; and
if it is determined that the editing mode is set, editing a print file requested to be printed according to an editing type input through a user interface of an image forming system and performing printing of the edited print file by a printer.

2. The print file editing method of claim 1, wherein the editing mode is set by any one of a graphic user interface provided by a printer driver and the user interface of the image forming system.

3. The print file editing method of claim 1, wherein determining whether the editing mode is set by the user comprises:
setting any one mode of a normal mode and the editing mode by the user; and
if the editing mode is set by the user, setting an editing type through the user interface by the user.

4. The print file editing method of claim 1, wherein the colors desired to be output from the image forming system are determined in accordance with the editing type.

5. The print file editing method of claim 1, wherein a printing sequence of each color that is to be performed in the image forming system is changed in accordance with the editing type.

6. The print file editing method of claim 1, wherein the colors desired to be output from the image forming system are determined and then the determined printing sequence of each color is changed in accordance with the editing type.

7. The print file editing method of claim 1, wherein editing a print file and performing printing the edited print file comprises:
if the colors desired to be output from the image forming system are determined in accordance with the editing type, performing rendering of the determined colors; and transferring the rendered print data for each color to a print engine.

8. The print file editing method of claim 1, wherein editing a print file and performing printing the edited print file comprises:
rendering the print file for each color that is to be printed; and
if the colors desired to be output from the image forming system are determined in accordance with the editing type, transferring print data of determined colors among the rendered print data for each color, to a print engine.

9. The print file editing method of claim 1, wherein editing a print file and performing printing the edited print file comprises:
rendering the print file for each color that is to be printed out; and
if the printing sequence of each color to be performed in the image forming system is determined in accordance with the editing type, transferring the rendered print data for each color to a print engine according to the color printing sequence.

10. The print file editing method of claim 1, wherein editing a print file and performing printing the edited print file comprises:
if the colors desired to be output from the image forming system are determined in accordance with the editing type, performing rendering of the determined colors; and
if the print sequence for each color to be performed in the image forming system is determined in accordance with the editing type, transferring the rendered print data for each color to a print engine according to the color printing sequence.

11. The print file editing method of claim 1, wherein editing a print file and performing printing the edited print file comprises:
rendering the print file for each color that is to be printed; and
if the colors desired to be output from the image forming system and the printing sequence of each color that is to be performed in the image forming system are determined in accordance with the editing type, transferring print data for each determined color among the rendered print data for each color to a print engine according to the determined color printing sequence.

12. A computer readable recording medium having embodied thereon a computer program for a print file editing method comprising:
determining whether an editing mode is set by a user; and
if it is determined that the editing mode is set, editing a print file requested to be printed, according to an editing type input through a user interface of an image forming system and performing printing the edited print file by a printer.

13. A print file editing apparatus in an image forming system comprising:
a manipulation unit through which if an editing mode is set by a user, an editing type is input by the user; and
a data processing unit which if a normal mode is set, renders a print file that is to be printed according to a preset printing sequence of each color, and if the editing mode is set, processes the print file that is to be printed according to the editing type.

14. The print file editing apparatus of claim 13, wherein the data processing unit controls rendering and/or transferring of the print file that is to be printed according to the colors desired to be output from the image forming system and/or a printing sequence of each color, which is to be performed in the image forming system, set by the editing type.

15. An image forming system comprising:
a manipulation unit through which if an editing mode is set by a user, an editing type is input by the user;
a data processing unit which if a normal mode is set, renders a print file that is to be printed out according to a preset printing sequence of each color, and if the editing mode is set, processes the print file requested to be printed out according to the editing type; and
a print engine unit which by using print data processed and transferred by the data processing unit, forms a print image on a predetermined recording medium.

16. The image forming system of claim 15, wherein the data processing unit controls rendering and/or transferring of the print file that is to be printed according to the colors desired to be output from the image forming system and/or a printing sequence of each color, which that is to be performed in the image forming system, set by the editing type.

17. The image forming system of claim 15, wherein if the colors desired to be output from the image forming system are determined by the editing type, the data processing unit renders the determined colors, and transfers the rendered print data for each color to the print engine unit.

18. The image forming system of claim 15, wherein the data processing unit performs rendering of the print file for each color requested to be printed out, and if the kind of colors desired to be output from the image forming system is determined by the editing type, transfers print data of colors determined among the rendered print data for each color to the print engine unit.

19. The image forming system of claim 15, wherein the data processing unit renders the print file for each color that is to be printed, and if the printing sequence for each color that is to be performed in the image forming system is determined with respect to the editing type, transfers the rendered print data for each color to the print engine unit according to the color printing sequence.

20. The image forming system of claim 15, wherein if the colors desired to be output from the image forming system are determined with respect to the editing type, the data processing unit renders the determined colors, and if the printing sequence of each color that is to be performed in the image forming system is determined with respect to the editing type, transfers the rendered print data for each color to the print engine unit according to the color printing sequence.

21. The image forming system of claim 15, wherein the data processing unit renders the print file for each color that is to be printed, and if the colors desired to be output from the image forming system and the printing sequence of each color that is to be performed in the image forming system are determined with respect to the editing type, transfers print data for each color determined among the rendered print data for each color to the print engine unit according to the determined color printing sequence.

22. A color image forming system including a print file editing apparatus, comprising:
a computer including:
a first data processing unit to convert document data written into the computer and requested to be printed into print data of plural colors using a print driver,
a first storage unit to store a variety of control programs required to implement functions of the computer including the printer driver,
a display, and
a manipulation unit by which user information on whether editing will be performed is input;
a printer system to print and edit print data, the printer system including:
a second data processing unit to control the printer system according to a preset program and by using an interpreter to convert the print data of a print file received from the first data processing unit into a printable data format, and to perform different rendering procedures for the print data converted by the interpreter depending on whether a normal mode or an editing mode is set through the manipulation unit; and
a communication interface to provide communication between the computer and the printer system.

23. The color image forming apparatus of claim 22, wherein the printer system further comprising:
an engine unit to print the printable data; and
an engine control unit to receive the printable data format print data converted by the second data processing unit for each color and send this print data to the engine unit.

24. The color image forming apparatus of claim 23, wherein the printer system further comprises:
a second storage unit to store a variety of control programs required to implement functions of the printer system and to temporarily store various data being generated by performing the control programs, print data and printing information received from the computer.

25. The color image forming apparatus of claim 22, wherein the printer system further comprises:
a second manipulation unit formed with a key matrix and a second display to generate data according to a key pushed by a user in order to select either the editing mode or the normal mode, and to execute operations relevant to the selected mode, and to output the data to the second data processing unit.

26. The color image forming apparatus of claim 25, wherein the second display displays the operational state of the printer system when each mode is performed in the second data processing unit.

27. The color image forming apparatus of claim 22, wherein the first manipulation unit is formed with an information input device including one of a keyboard, a mouse, or a touch panel, and through a user graphic interface provided by the printer driver, by which user information on whether editing will be performed in the printer system is input.

28. The color image forming apparatus of claim 27, wherein the printer driver is stored in the first storage unit and is programmed such that a checkbox indicating whether editing will be performed in the printer system can be provided in the user graphic interface.
